(19) United States
(12) Patent Application Publication
(10) Pub. No.: US 2011/0103635 A1
(43) Pub. Date: May 5, 2011

(54) HEADPHONE

(75) Inventors: Michihito Asakura, Tendo-shi (JP); Oriaki Nihei, Tendo-shi (JP); Hironori Oishi, Kawasaki-shi (JP); Atsushi Shirata, Tendo-shi (JP)

(73) Assignees: Pioneer Corporation, Kawasaki-shi, Kanagawa (JP); Tohoku Pioneer Corporation, Tendo-shi, Yamagata (JP)

(21) Appl. No.: 12/933,342

(22) PCT Filed: Oct. 2, 2008
(86) PCT No.: PCT/JP2008/067899

§ 371 Date: Dec. 22, 2010

(51) Int. Cl. H04R 1/10

(52) U.S. Cl. 381/378

(57) ABSTRACT

There are provided headphone which can provide a relatively small storage space when being carried around and which can prevent an unexpected breakage of the headphone. A headphone 1 includes a C-shaped headband 2, a band-plate-like arm part 3, a sound emission part 4 supported by the arm part 3, a first attachment portion 7 and a first maintaining body 48. The first attachment portion 7 rotatably connects the arm part 3 at a central portion of the sound emission part 4 on a side opposite to a sound emitting side of the sound emission part 4 about a first axis P1 along a width direction of the arm part 3. The first to maintaining body 48 maintains relative positions of the sound emission part 4 and the arm part 3 around the first axis P1.

### FIELD OF THE INVENTION

The present invention relates to a headphone used to be worn on a person's head.

### DESCRIPTION OF THE RELATED ART

Conventionally, there have been various headphones used to be worn on person's heads (refer for example to Patent Literature 1). The headphone disclosed in Patent Literature 1 includes a pair of sound emission parts receiving a speaker unit producing a sound, a bridge-shaped arm part supporting the sound emission part, a headband to be worn on the person's head and a rotation supporting part supporting the arm part so the arm part rotates with respect to the headband.

The arm part includes a shaft portion rotatably attached to the rotation supporting part, a C-shaped ring portion having a central portion connected with the shaft portion and arranged along an outer edge portion of the sound emission part, and a rotation shaft portion projecting from both ends of the ring portion inwardly with respect to the ring portion and rotatably engaged with the outer edge portion of the sound emission part.

For the headphone described above, the rotation supporting part positions the sound emission part in a given direction such that the sound emission part closely contacts with the head and reproduced sound produced by the speaker unit can be brought to the person's ear.

[Patent Literature 1] Japanese Utility Model Publication No. S63-20233

### SUMMARY OF THE INVENTION

### Technical Problems

For the headphone disclosed in Patent Literature 1 described above, the sound emission part and the arm part are arranged so as to rotate with respect to each other without any force applied by a spring or the like. Thus, a direction of the sound emission part with respect to the arm part changed easily. Consequently, the sound emission part was easily rotated beyond a maximum allowable rotation range of the arm part, and the rotation supporting part and the arm part were broken easily.

Moreover, for the headphone disclosed in Patent Literature 1 described above, since the ring portion of the arm part is formed into a C-shape and arranged along the outer edge of the sound emission part, the arm part grew to size. Consequently, when carrying the headphone around, a relatively large storage space with respect to a carrying bag and such was required.

The present invention is intended to address these problems. Therefore, an object of the present invention is to provide headphone which can provide a relatively small storage space required when carrying the headphone around and which can prevent an unexpected breakage of the headphone.

### Solution to Problem

In order to solve the above-described problem and achieve the above-described object, there is provided a headphone having: a headband; a band-plate-like arm part connected to the headband; a sound emission part supported by the arm part; a first attachment portion rotatably connecting the arm part with a central portion of the sound emission part on a side opposite to a sound emitting side of the sound emission part about a first axis along a width direction of the arm part; and a first maintaining element maintaining relative positions of the sound emission part and the arm part about the first axis.

### BRIEF DESCRIPTION OF THE DRAWINGS

FIG. 1 is a perspective view of headphone according to one exemplary embodiment of the present invention;

FIG. 2 is a perspective view of a second attachment portion, a third attachment portion and a second maintaining body shown in II-marked portion in FIG. 1 seen from back side;

FIG. 3 is an exploded perspective view of the second attachment portion, the third attachment portion and the second maintaining body shown in FIG. 2;

FIG. 4 is another exploded perspective view of the second attachment portion, the third attachment portion and the second maintaining body shown in FIG. 2;

FIG. 5 is an exploded perspective view of the second maintaining body shown in FIG. 4;

FIG. 6 is an exploded perspective view of a first attachment portion and a first maintaining body of the headphone shown in FIG. 1;

FIG. 7 is an exploded perspective view showing a portion of the first attachment portion and the first maintaining body shown in FIG. 6;

FIG. 8 is a cross-sectional view showing a portion of the first attachment portion and the first maintaining body shown in FIG. 6;

FIG. 9 is a perspective view illustrating a state in which a helical coil spring shown in FIG. 3 is positioning an arm part in a neutral position;

FIG. 10 is a perspective view illustrating a state in which the helical coil spring shown in FIG. 3 is exerting a force on the arm part towards the neutral position;

FIG. 11 is a cross-sectional view showing the second maintaining body shown in FIG. 4;

FIG. 12 is a cross-sectional view showing a sound emission part shown in FIG. 11 being folded;

FIG. 13 is a cross-sectional view showing a portion of a modified example of the first attachment portion and the first maintaining body shown in FIG. 8;

FIG. 14 is an exploded perspective view showing a portion of a modified example of the first attachment portion and the first maintaining body shown in FIG. 7;

FIG. 15 is a perspective view showing a connection hole of the second attachment portion shown in FIG. 12;

FIG. 16 is another perspective view showing the connection hole of the second attachment portion shown in FIG. 15;

FIG. 17 is another exploded perspective view of the first attachment portion and the first maintaining body of the headphone shown in FIG. 1;

FIG. 18 is a perspective view showing a portion of the first attachment portion and the first maintaining body shown in FIG. 6; and

FIG. 19 is a perspective view showing a cross-section of a portion of the first attachment portion and the first maintaining body shown in FIG. 18.

### REFERENCE SIGNS LIST

1 headphone
2 headband
3 arm part
4 sound emission part
5 second attachment portion
6 third attachment portion
7 first attachment portion
12 first connecting member
16 helical coil spring
22 elastic deformation portion
23 stick-like portion
24 second connecting member
25 cutout
27 shaft
28 connecting member
30 second maintaining body (second maintaining element)
32 circular recess (engagement counter member)
34 projecting plate (engaging member)
35 coil spring (second force-exerting member)
38 case holder (receiving member)
39 cutout
40 receiving part
42 sliding connection shaft (receiving counter member)
43 holder main body (plate portion)
44 tubular portion
48 first maintaining body (first maintaining element)
49 linear convex portion (convex portion)
50 linear concave portion (concave portion)
51 coil spring (first force-exerting member)
52 back face (inner face)
58 end face
P1 first axis
P2 second axis
P3 third axis

### DESCRIPTION OF EMBODIMENTS

One embodiment of the present invention will be explained below. For a headphone according to one embodiment of the present invention, a first attachment portion rotatably connecting with a sound emission part and an arm part is attached at a central portion of the sound emission part. Consequently, the first attachment portion can be prevented from being large, and a storage space can become relatively small. In addition, an unexpected breakage of the first attachment portion can be prevented.

Furthermore, there is provided a first maintaining element maintaining relative positions of the sound emission part and the arm part about a first axis. Consequently, even with the first attachment portion, the sound emission part can be prevented from rotating slightly with respect to the arm part when being carried around, preventing generation of an unwanted noise. Also, the arm part can be prevented from rotating beyond a maximum allowable rotation range of the first attachment portion, preventing an unexpected breakage of the first attachment portion and such.

Furthermore, the first maintaining element may include an end face of a receiving counter member and an inner face of a receiving part which are arranged to be engaged with each other, and a first force-exerting member exerting a force in a direction of moving the end face and the inner face towards each other. In this case, the first maintaining element can reliably maintain relative positions of the sound emission part and the arm part about the first axis.

Moreover, one of the end face and the inner face may include a convex portion, and the other one of the end face and the inner face may include a concave portion. In addition, the convex portion and the concave portion may be formed so as to extend linearly. In these cases, the first maintaining element can reliably maintain relative positions of the sound emission part and the arm part about the first axis.

Furthermore, the first attachment portion may include a cutout provided at the arm part and a receiving member placed within the cutout and receiving the first force-exerting member. In this case, since the receiving member is placed within the cutout, the first attachment portion can be downsized.

Furthermore, the receiving member may include a plate portion formed to be a plate-like shape and attached to the sound emission part and a tubular portion connecting to the plate portion and receiving the first force-exerting member. In this case, the first attachment portion can connect the arm part and the sound emission part about the first axis without increasing the number of components.

The arm part may be curved convexly in a direction opposite to a sound emitting side. In this case, the headphone can be received within a relatively small storage space.

Furthermore, there may be provided a second attachment portion connecting with a headband and the arm part rotatably about a second axis. In this case, the sound emission part can be positioned further in a given direction.

Furthermore, in addition to the second attachment portion, there may be provided a third attachment portion connecting the second attachment portion and the arm part rotatably about a third axis perpendicular to the second axis. In this case, the sound emission part can be folded such that the sound emission part is in close contact with the headband.

Furthermore, there may be provided a force-exerting element exerting a force to the arm part towards a neutral position when the arm part supporting the sound emission part is rotated with respect to the headband. In this case, when the arm part is returned back in the neutral position after the arm part supporting the sound emission part is rotated in use, the arm part is returned back in the neutral position by an exerting force of the force-exerting element.

Accordingly, in a state in which no external force is applied to the sound emission part, such as when not in use, the arm part is maintained in the neutral position. Thus, the sound emission part can be prevented from rotating slightly with respect to the headband when being carried around. And, an unwanted noise can be prevented from generating. In addition, since the arm part, i.e. the sound emission part, can be positioned in the neutral position, the arm part can be prevented from rotating beyond a maximum allowable rotation range of the second attachment portion. And, an unexpected breakage of the second attachment portion and such can be prevented.

Furthermore, in the present invention, the force-exerting element may include an annular elastic deformation portion and a pair of stick-like portions. One stick-like portion is attached to the arm part and the other stick-like portion is attached to the headband. In this case, the force-exerting element can exert a force to the arm part towards the neutral position with a simple structure.

Furthermore, there may be provided a second maintaining element maintaining relative positions of the second attachment portion and the arm part about a third axis. In this case, even with the third attachment portion provided in addition to the first attachment portion and the second attachment portion, the sound emission part can be prevented from rotating slightly with respect to the headband when being carried around, preventing generation of an unwanted noise. Also, the arm part can be prevented from rotating beyond a maximum allowable rotation range of the third attachment portion. And, an unexpected breakage of the third attachment portion and such can be prevented.

Furthermore, there may be provide a connecting member integrally including a first connecting member constituting the second attachment portion and a second connecting member constituting the third attachment portion. In this case, even with the third attachment portion provided in addition to the first attachment portion and the second attachment portion, an increase in the number of components can be prevented.

Furthermore, the first connecting member may be formed into a tubular shape receiving the force-exerting element and the second connecting member may be formed into a tubular shape receiving a shaft. In this case, even with the third attachment portion provided in addition to the first attachment portion and the second attachment portion, the headphone can be prevented from being large.

Furthermore, the second maintaining element may include an engagement counter member provided on an outer circumferential face of the second connecting member in a circumferential direction at an interval, an engagement member arranged to project from and retract into the arm part and arranged to engage with the engagement counter member, and a second force-exerting member exerting a force on the engagement member towards the outer circumferential face of the second connecting member. In this case, the second maintaining element can reliably maintain relative positions of the second attachment portion and the arm part about the third axis.

Furthermore, the arm part may include a cutout for disposing the second connecting member and the shaft may penetrate through the arm part and the second connecting member. In this case, downsizing can be achieved.

Furthermore, a plurality of receiving counter members may be provided, and the first force-exerting element may be provided between these receiving counter members. In this case, the first maintaining element can further reliably maintain relative positions of the sound emission part and the arm part about the first axis.

### Exemplary Embodiment

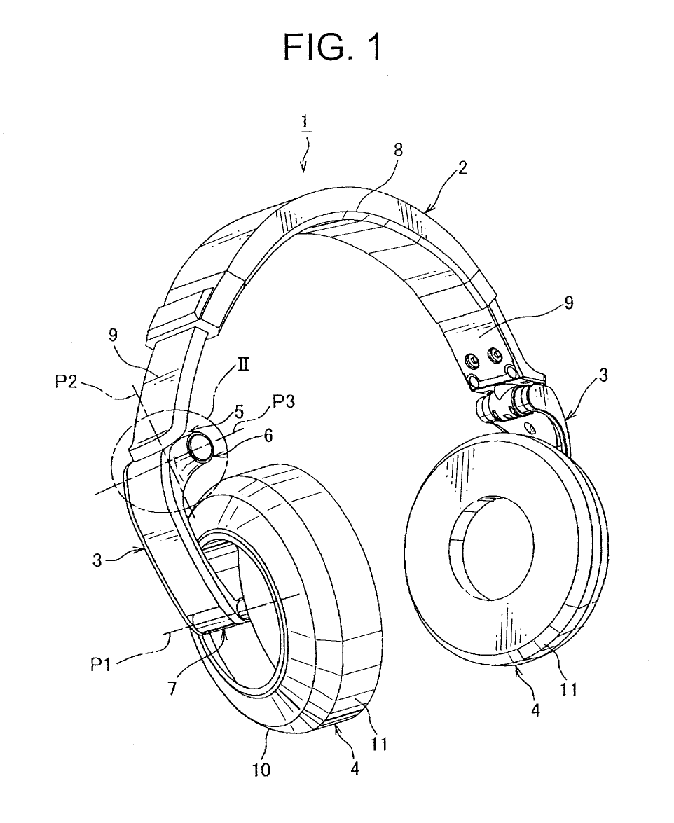

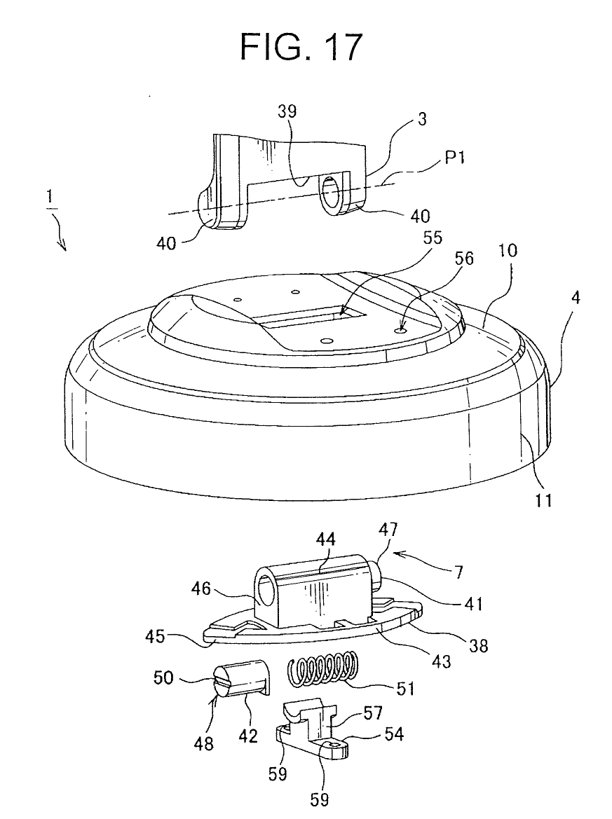

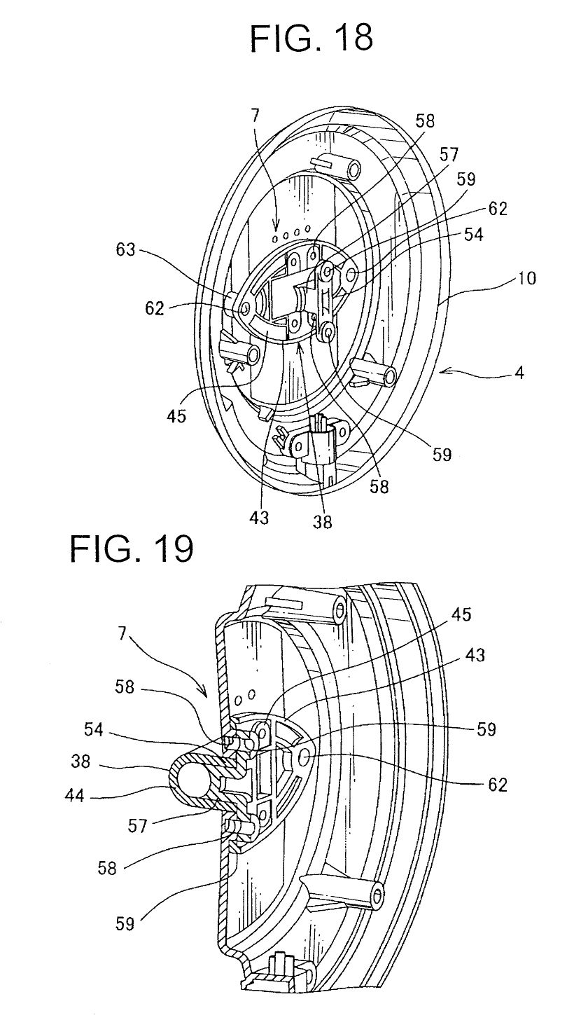

One exemplary embodiment of the present invention will be explained with reference to FIG. 1 through FIG. 12 and FIG. 15 through FIG. 19. A headphone 1 shown in FIG. 1 is worn on a person's head, produces a sound and transmits the sound (also referred as sound information) to the person.

The headphone 1, as shown in FIG. 1, include a headband 2, a pair of arm parts 3, a pair of sound emission parts 4, a pair of second attachment portion 5, a pair of third attachment portion 6 and a pair of first attachment portions 7.

The headband 2, as shown in FIG. 1, includes a main body portion 8 and a pair of telescopic portions 9 telescopically attached to both end portions of the main body portion 8, respectively, and the headband 2 is formed into a C-shape. The headband 2 is formed into a band-plate-like shape curved gently along a shape of the person's head, so a planar shape of the headband 2 is formed into the C-shape from the main body portion 8 to the telescopic portions 9. The headband 2 is arranged to be put on the person's head.

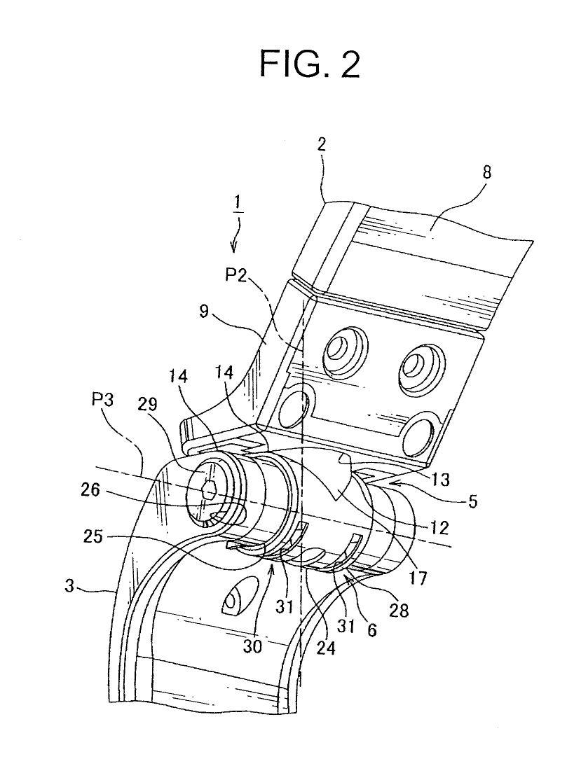

The arm part 3 is formed into a band-plate-like shape curved from one end portion of the arm part 3 adjacent to the headband 2 to the other end portion of the arm part 3 adjacent to the sound emission part 4 and curved convexly in a direction opposite to a later-described sound emitting side of the sound emission part 4. As shown in FIG. 2, the one end portions of the arm parts 3 are attached to both end portions of the telescopic portion 9, i.e. the headband 2, via the second attachment portion 5 and the third attachment portion 6.

The sound emission parts 4 is formed into a thick circular plate like shape. The sound emission part 4 includes a speaker case 10 constituted of rigid synthetic resin and formed into a thick circular plate, a speaker unit received in the speaker case 10 and a cushion member 11. The speaker case 10 includes an aperture and such for transmitting a sound produced by the speaker unit to the ear on a side facing the person's ear (hereinafter called a sound emitting side) when the headband 2 is worn on the person's head. The speaker unit, when voice currents are supplied thereto, produces a sound according to the voice currents. The cushion member 11 is constituted of an elastic deformable material such as polyurethane resin foam or nonwoven fabric, is formed into an annular shape and is attached at the speaker case 10 entirely from the sound emitting side and an outer edge portion of the speaker case 10. The sound emission part 4 is attached to (supported by) the arm part 3 via a first attachment portion 7. Since the cushion member 11 contacts with the person's ear so as to cover the ear, a space formed between the sound emission part 4 and the person's ear can be sealed, thus the acoustic characteristic can be improved. Furthermore, transmission of a sound from outside or leaking out of a sound to outside can be prevented.

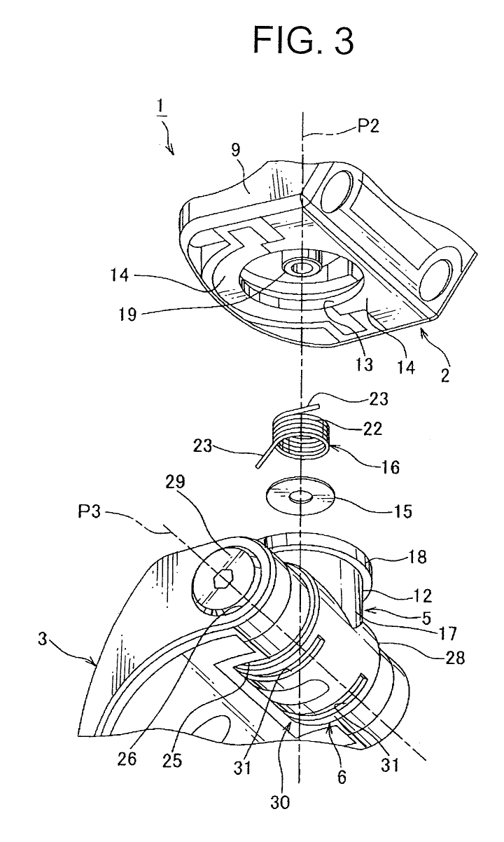

The second attachment portion 5, as shown in FIG. 3, includes a first connecting member 12 to which the arm part 3 is attached via the third attachment portion 6, a connection hole 13 provided at the telescopic portion 9, i.e. the headband 2, a pair of presser members 14, a washer 15 and a helical coil spring 16 as a force-exerting element.

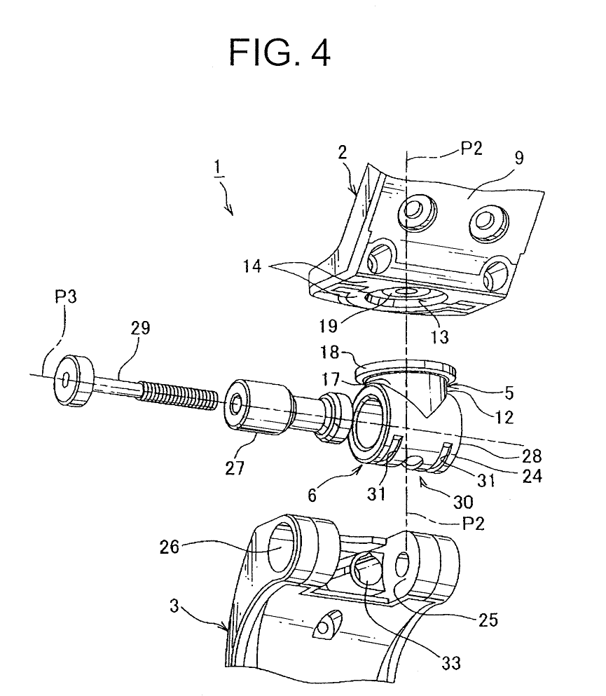

The first connecting member 12, as shown in FIG. 4, includes a main body portion 17 formed into a cylinder-like shape and a flange portion 18 projecting in a direction toward the outer circumference from an edge of the main body portion 17 adjacent to the telescopic portion 9, i.e. the headband 2.

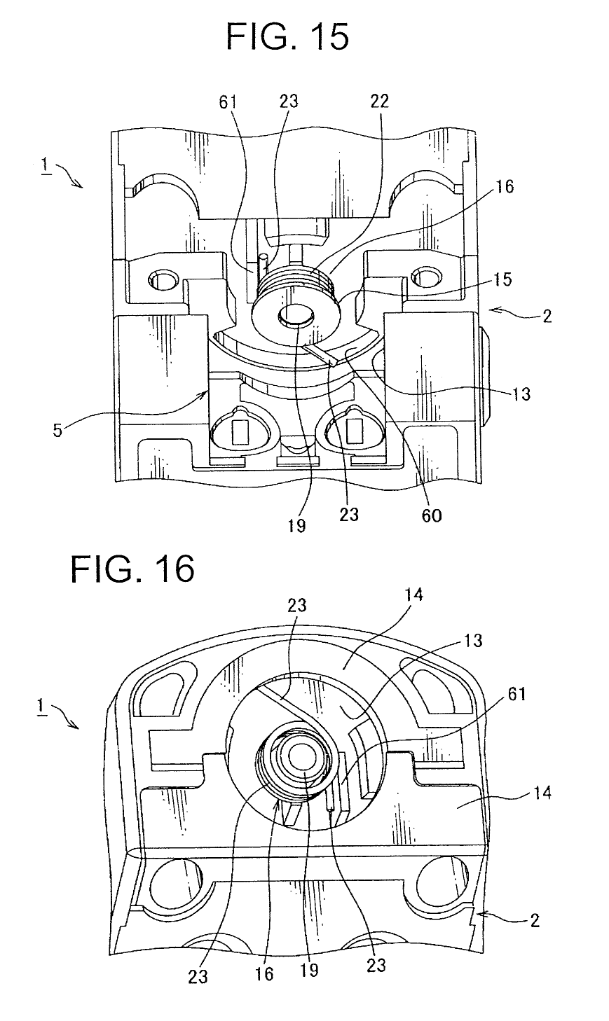

The connection hole 13 is formed to be concave in respect with an end face of the telescopic portion 9. The connection hole 13 has a circular planar shape and is formed into a shape similar to the flange portion 18 of the first connecting member 12 so the flange portion 18 can rotate within the connection hole 13. However, as long as the flange portion 18 can rotate within the connection hole 13, for example, the flange portion 18 may be formed into a circular shape while the connection hole 13 may be formed into an ellipsoidal or polygonal shape, or alternatively, the flange portion 18 may be formed into an ellipsoidal or polygonal shape while the connection hole 13 may be formed into a circular shape, and it is not limited thereto. As shown in FIG. 3, a center of a bottom face of the connection hole 13 is provided with a projection 19 projecting from the bottom face and for positioning the helical coil spring 16. In addition, as shown in FIG. 15, a concave portion 6 concaved with respect to the bottom face is provided circumferentially at an outer edge portion of the bottom face of the connection hole 13.

Furthermore, the flange portion 18 of the first connecting member 12 includes a convex projection 20 inserted into the concave portion 60 of the connection hole 13 and engages with the concave portion 60 of the connection hole 13, thereby regulates the rotation of the first connecting member. The concave portion 60 of the connecting hole 13 is formed into an arc-like shape, however, the shape of the concave portion 60 may be, for example, but not limited to, an ellipsoidal shape, as long as the rotation of the first connecting member can be regulated. Alternatively, a projection may be formed at the connection hole 13 while the concave portion 60 may be formed at the first connecting member, and changes can be made arbitrarily.

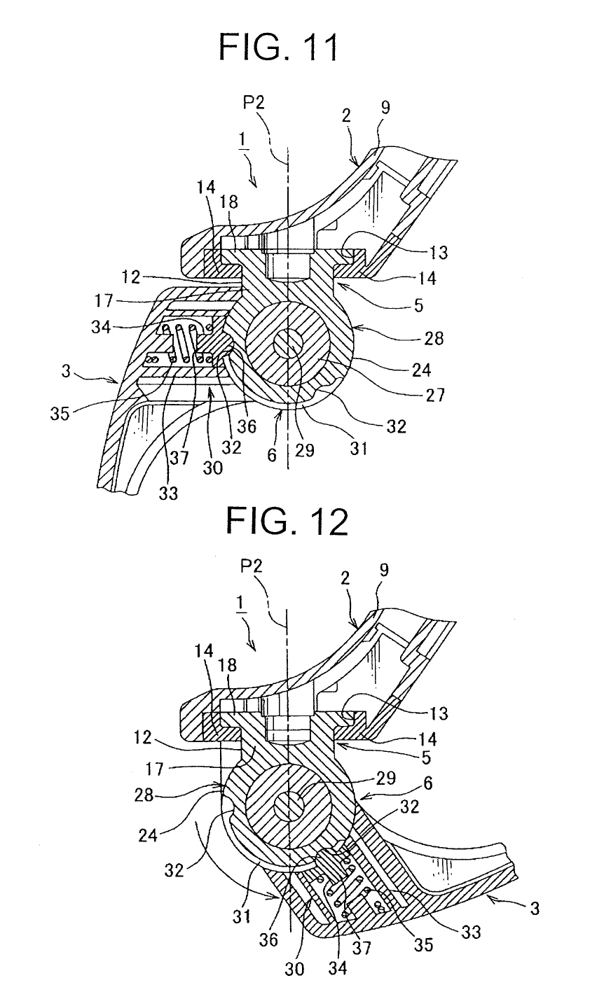

Furthermore, the connection hole 13, as shown in FIG. 11 and FIG. 12, receives the flange portion 18 and an end portion of the main body portion 17 of the first connecting member 12 adjacent to the headband 2.

The pair of presser members 14 is formed into a plate having a C-like planar shape. The pair of presser members 14 is attached to the telescopic portion 9. The pair of presser members 14, when attached to the telescopic portion 9, positions the first connecting member 12 between the pair of presser members 14 and positions the flange portion 18 between the pair of presser members 14 and between the bottom face of the connection hole 13 and the presser member 14, as shown in FIG. 11 and FIG. 12. When the flange portion 18 is positioned between the presser member and the bottom face of the connection hole 13, the first connecting member 12 can rotate about a later-described second axis P2 with respect to the headband 2.

The washer 15 is formed into a ring-like shape. The washer 15 is received in the connection hole 13 and is placed in a position in the main body portion 17 adjacent to the headband 2. The washer 15, together with the helical coil spring 16, is fitted to the projection 19 for positioning the helical coil spring 16 and is fixed by a screw or the like.

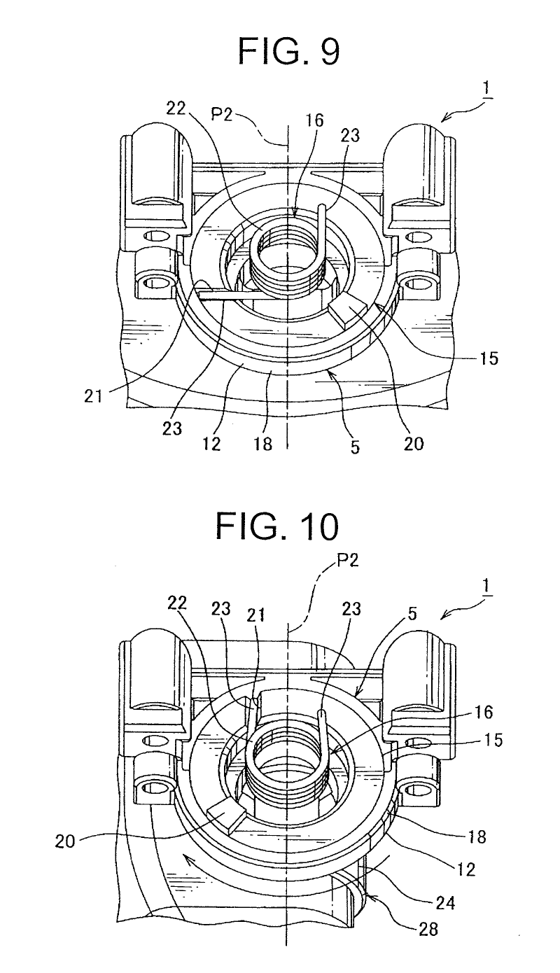

The flange portion 18 of the first connecting member 13, as shown in FIG. 9 and FIG. 10, includes the projection 20 for regulation of rotation and an attachment groove 21. The projection 20 for regulation of rotation projects from a surface of the flange portion 18 of the first connecting member 13 adjacent to the telescopic portion 9. When the first connecting member 12, i.e. the arm part 3, is attached to the telescopic portion 9, i.e. the headband 2, and is rotated about the later-described second axis P2, the projection 20 for regulation of rotation contacts with the concave portion 60 provided at the bottom face of the connection hole 13 and thereby regulates a range within which the first connecting member 12, i.e. the arm part 3 can rotate. The attachment groove 21 is formed to be concave on the surface of the flange portion 18 of the connecting member 13 adjacent to the telescopic portion 9. The attachment groove 21 receives a later-described one stick-like portion 23 of the helical coil spring 16 and fixes the one stick-like portion 23.

For the second attachment portion 5 having the above-described structure, when the first connecting member 12 is attached to the telescopic portion 9, i.e. the headband 2, the first connecting member 12 can rotate with respect to the headband 2 about the second axis P2 (indicated by a dotted line in FIG. 1) which is parallel to a direction from the headband 2 towards the arm part 3. In other word, since the first connecting member 12 is attached to the arm part 3 via the third attachment portion 6, the first connecting member 12 rotatably connects the headband 2 and the arm part 3 so as to rotate about the second axis P2. The second axis P2 is concentric with the first connecting member 12 (the second axis P2 corresponds to an axis of the first connecting member 12).

The helical coil spring 16 is constituted of a wire material made of metal such as iron or phosphor bronze or the like and, as shown in FIG. 9 and FIG. 10, includes an elastic deformation portion 22 formed into a ring-like shape with the wire material wound and a pair of stick-like portions 23 formed into a stick-like shape and extending in a direction from the elastic deformation portion 22 to an outer circumference of the elastic deformation portion 22. The helical coil spring 16 is received inside the first connecting member 12 and is positioned by inserting the above-described projection 19 of the connection hole 13 into the helical coil spring 16. The helical coil spring 16, with the one stick-like portion 23 being received within the attachment groove 21, is attached (fixed) to the telescopic portion 9 together with the washer 15 by a screw or the like. In addition, for the helical coil spring 16, the other stick-like portion 23 is attached (fixed) to an inner face of the connection hole 13, i.e. the headband 2.

Particularly, as shown in FIG. 15 and FIG. 16, the other stick-like portion 23 extends along a side face of a wall portion 61 having a shape projecting from the bottom face portion of the connection hole 13 and is fixed to the wall portion 61. The wall portion 61 is formed on an opposite side of the concave portion 60 across the helical coil spring 16 such that a movement of the one stick-like portion 23 in a circumferential direction is not encumbered. It is noted that although the wall portion 61 is formed in a direction intersecting with a direction in which the concave portion 60 extends, it is not limited thereto, and the concave portion 60 may be formed along the direction in which the concave portion 60 extends, and changes can be made arbitrarily so as to obtain a desired elastic restoring force.

For the helical coil spring 16, since the one stick-like portion 23 is attached at the first connecting member 12 (the arm part 3) and the other stick-like portion 23 is attached at the connection hole 13 (the headband 2), when the second attachment portion 5, i.e. the arm part 3, is rotated about the second axis P2, as shown in FIG. 10, the elastic deformation portion 22 elastically deforms so as to expand or shrink (FIG. 10 shows an expanded case). Therefore, the helical coil spring 16 obviously produces an elastic restoring force returning the arm part 3 back in a non-deformed neutral state. In FIG. 9, the one stick-like portion 23 and the other stick-like portion 23 are drawn out from the elastic deformation portion 22 so as to be mutually perpendicular. However, it is not limited thereto, and the plurality of stick-like portions 23 may be drawn out at a predetermined angle to each other such as at an angle of 120 degrees, and changes can be made arbitrarily in order to obtain a predetermined elastic restoring force. Alternatively, the helical coil spring 16 may be replaced with one elastic member (such as resin material including natural resin such as rubber and polyurethane resin such as spunbond) wound around the projection 19 of the connection hole 13 to obtain the elastic restoring force, and changes can be made arbitrarily. In the neutral state in which the helical coil spring 16 shown in FIG. 9 is not elastically deformed, the headband and the arm part 3 are positioned in the neutral position in which a surface of the telescopic portion 9, i.e. the headband 2, and a surface of the arm part 3 are substantially parallel to each other (shown in FIG. 1). Accordingly, the helical coil spring 16, when the arm part 3 is rotated about the second axis P2, exerts a force on the arm part 3 towards the neutral position in which the arm part 3 and the headband 2 are parallel to each other. In the description, the neutral position corresponds to a position in which a bump produced between the arm part 3 and the headband 2 is minimized, but the neutral position described in the description is not defined by a position in which the surface of the headband 2 and the surface of the arm part 3 are completely parallel to each other. In other words, the neutral position corresponds to a position in which an angle between a direction in which the surface of the arm part 3 extends (a direction from the sound emission part 4 towards the headband 2) and a direction in which the surface of the headband 2 extends (a direction from the arm part 3 towards a central portion of the headband 2) is minimized, but the neutral position described in the description is not defined by the surface of the headband 2 and the surface of the arm part 3 being at an angle of exactly zero degrees.

The third attachment portion 6, as shown in FIG. 4, includes a second connecting member 24, a cutout 25 provided at the arm part 3, a through hole 26 provided at the arm part 3 and a shaft 27.

The second connecting member 24 is formed into a circular tube. The second connecting member 24, with an axis of the second connecting member 24 intersecting with (perpendicularly, in the shown example) an axis of the first connecting member 12, connects to an end portion of the first connecting member 12 and formed integrally with the first connecting member 12. That is, the second connecting member 24 is provided integrally with the first connecting member 12, thereby constituting a connecting member 28. Thus, the headphone 1 includes the connecting member 28.

The cutout 25 is provided at the one end portion of the arm part 3 (corresponds to the end portion adjacent to the headband 2) and is formed such that a portion of the arm part 3 is cut out from the one end portion towards a central portion of the arm part 3. The second connecting member 24 is placed in the cutout 25. The through hole 26 is provided at the one end portion of the arm part 3. The through hole 26 is a hole having a circular cross-section and is provided at a position so as to be concentric with (communicated with) the second connecting member 24 in the cutout 25.

The shaft 27 is formed into a cylinder-like shape and has an outer diameter varying in a stepwise manner. The shaft 27 is inserted into the through hole 26 and the second connecting member 24. That is, the shaft 27 penetrates through the arm part 3 and the second connecting member 24. The shaft 27 is fixed to the arm part 3 by a fixing bolt 29 (shown in FIG. 4). With the shaft 27 inserted into the second connecting member 24 and fixed to the arm part 3 by the fixing bolt 29, the connecting member 24 is attached to the arm part 3. In addition, since the shaft 27 is inserted into the second connecting member 24, the second connecting member 24 receives the shaft 27. Furthermore, when the shaft 27 inserted into the second connecting member 24 is fixed to the arm part 3 by the fixing bolt 29, the second connecting member 24 can rotate with respect to the arm part 3 about a third axis P3 substantially parallel to a width direction of the headband 2 and perpendicular to the second axis P2.

The third attachment portion 6 having the above-described structure rotatably connects the second attachment portion 5 and the arm part 3 so as to rotate about the third axis P3 (indicated by a dotted line in FIG. 1). The third axis P3 is concentric with the second connecting member 24 (corresponds to an axis of the second connecting member 24). Thus, the third attachment portion 6 rotates the arm part 3 about the third axis P3 with respect to the second attachment portion 5, i.e. the headband 2, thereby allowing the arm part 3, i.e. the sound emission part 4, to displace between a position in which the sound emission part 4 is unfolded as shown in FIG. 11 and a position in which the sound emission part 4 is folded as shown in FIG. 12.

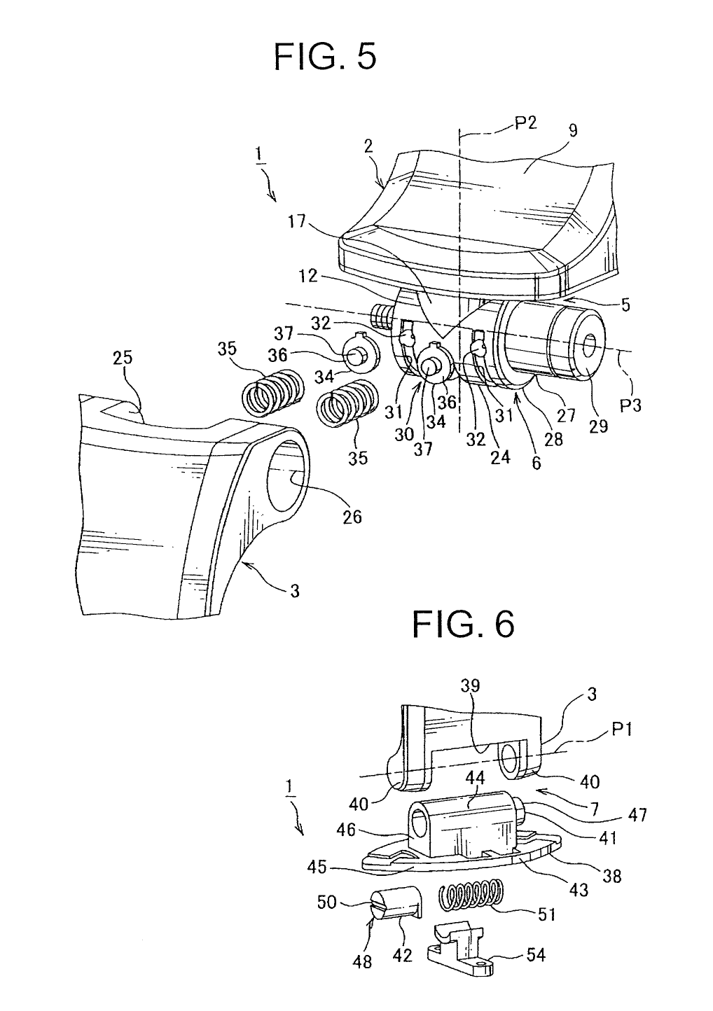

Furthermore, the headphone 1, as shown in FIG. 5, includes a second maintaining body 30 as a second maintaining element. The second maintaining body 30, as shown in FIG. 5, includes a plurality of grooves 31, a plurality of circular recesses 32 as engagement counter members, a plurality of receiving holes 33 (shown in FIG. 11 and FIG. 12), a plurality of projecting plates 34 as engagement members and a plurality of coil springs 35 as second force-exerting members.

There are provided two grooves 31 in the example shown in the figures. The respective grooves 31 are concave on an outer circumferential face and extend along a circumferential direction of the second connecting member 24.

The two grooves 31 are arranged along the axis of the second connecting member 24, i.e. the third axis P3, at an interval. The number of the groove 31 is not limited to two. A plurality of grooves 31, such as three or four grooves 31, may be provided. Also, a plurality of circular recesses 32 as the engagement counter members may be formed so as to correspond with the number of the grooves 31.

A plurality of circular recesses 32 are provided at the each groove 31. In the example shown in the figures, two circular recesses 32 are provided at the each groove 31, thus total of four circular recesses 32 are provided. The circular recesses 32 are arranged along a longitudinal direction of the groove portion 31, i.e. the circumferential direction of the second connecting member 24, at an interval. The circular recess 32 is formed to be concave on the outer circumferential face of the second connecting member 24 and a bottom face of the groove 31. The circular recess 32 has a circular planar shape. In place of the circular recess 32, a recess having an ellipsoidal or polygonal shape may be formed on the outer circumferential face of the second connecting member 24, and changes may be made arbitrarily.

In the example shown in the figures, there are provided two receiving holes 33. The receiving hole 33 is provided at the above-described one end portion of the arm part 3 and an opening portion of the receiving hole 33 faces the groove 31 provided at the second connecting member 24.

In the example shown in the figures, there are provided two projecting plates 34. The projecting plate 34 integrally includes a hemispherical shaped spherical portion 36 and a cylinder-like tubular portion 37 connecting to a flat bottom face of the spherical portion 36. The spherical portion 36 and the tubular portion 37 are arranged concentric to each other. The spherical portion 36 closely contacts with a bottom face of the circular recess 32 and engages with the circular recess 32. In addition, the tubular portion 37 has smaller diameter than the spherical portion 36. The projecting plate 34, while the spherical portion 36 being arranged to face the second connecting member 24, is loosely inserted into the receiving hole 33. Since the projecting plate 34 is loosely inserted into the receiving hole 33, the projecting plate 34 can project and retract from the arm part 3 to the second connecting member 24. In addition, since the spherical portion 36 engages with the circular recess 32, the projecting plate 34 can obviously engage with the circular recess 32. As long as the spherical portion 36 is shaped correspondingly with the circular recess 32, the spherical portion 36 may be an ellipsoidal portion or a polygonal portion in case in which the circular recess 32 is replaced with an ellipsoidal recess or a polygonal recess, and changes may be made arbitrarily.

In the example shown in the figures, there are provided two coil springs 35. The coil spring 35 is received inside the receiving hole 33 and is placed between the bottom face of the receiving hole 33 and the projecting plate 34. The coil spring 35 is arranged between the bottom face of the receiving hole 33 and exerts a force on the projecting plate 34 towards the second connecting member 24. In place of the coil spring 35, a member constituted of rubber or a member constituted of polyurethane resin may be arranged as an elastic member, as long as such member can exert a force on the projecting plate 34 towards the second connecting member 24. Also, other known elastic members may be selected arbitrarily and employed in place of the coil spring 35 with the purpose of, for example, suitably adjusting a force to be exerted.

For the second maintaining body 30 having the above-described structure, the coil spring 35 exerts the force to the projecting plate 34 towards the second connecting member 24 and the projecting plate 34 is received inside the receiving hole 33 facing to the groove 31. Thus, the spherical portion 36 of the projecting plate 34 can closely contact with the groove 31. Moreover, for the second maintaining body 30, the spherical portion 36 of the projecting plate 34 is inserted into the circular recess 32 and engages with this circular recess 32, thereby maintains relative positions of the second attachment portion 5 and the arm part 3 about the third axis P3.

The first attachment portion 7, as shown in FIG. 6, FIG. 8 and FIG. 17 through FIG. 19, includes a case holder 38 as a receiving member to be attached to the sound emission part 4, a cutout 39, receiving part 40 formed integrally with the arm part 3, a fixing connection shaft 41 and a sliding connection shaft 42 as a receiving counter member.

The case holder 38 integrally includes a holder main body 43 as a plate-like plate portion to be attached at a central portion of the sound emission part 4 on a side opposite to (reverse side of) the sound emitting side of the sound emission part 4 and a tube-like tubular portion 44 connecting to the holder man body 43. The holder main body 43 is fixed to above-described the central portion of the back side of the sound emission part 4. That is, the holder main body 43 is attached to the sound emission part 4. The tubular portion 44 is formed into a cylinder-like shape and an axis of the tubular portion 44 is arranged substantially parallel to a surface of the holder main body 43. The tubular portion 44, i.e. the case holder 38, receives a later-described coil spring 51.

The cutout 39 is provided at the other end portion of the arm part 3 (corresponds to an end portion adjacent to the sound emission part 4) and is formed such that a portion of the arm part 3 is cut out from an end of the other end portion towards the central portion of the arm part 3. The tubular portion 44 of the case holder 38 is arranged in the cutout 39.

The receiving part 40 is formed into a tubular shape having a bottom portion. Also, a pair of (i.e. a plurality of) receiving parts 40 are provided at the other end portion of the arm part 3. The receiving part 40 opens into the cutout 39. The receiving parts 40 are provided to be concentric with (communicate with) the tubular portion 44 of the case holder 38 arranged within the cutout 39. In addition, the receiving parts 40 are arranged in a position so the later-described shafts 41, 42 and the coil spring 51 are positioned between the receiving parts 40.

The fixing connection shaft 41 integrally includes a plate-like fixing portion 45, an extending portion 46 provided to stand from the fixing portion 45 and a cylinder-like circle tube portion 47 having one end connecting to the extending portion 46. The fixing portion 45 is disposed on the above-described back side of the sound emission part 4 and fixed to the sound emission part 4. The circle tube portion 47 is received inside the case holder 38 while a tip end portion of the circle tube portion 47 is inserted into the receiving part 40. Thus, the circle tube portion 47 is inserted into the receiving part 40 and free to rotate with respect to the receiving part 40.

The sliding connection shaft 42 is formed into a cylinder-like shape. The sliding connection shaft 42 is received inside the tubular portion 44 of the case holder 38 while a tip end portion of the sliding connection shaft 42 is inserted into the receiving part 40. The sliding connection shaft 42 is arranged at the sound emission part 4 via the case holder 38 by being received within the tubular portion 44 of the case holder 38. The sliding connection shaft 42, with the tip end portion thereof inserted into the receiving part 40, is received inside the receiving part 40 so as to be free to rotate with respect to the receiving part 40 around the first axis P1. Thus, the sliding connection shaft 42 is inserted into the receiving part 40 and free to rotate with respect to the receiving part 40. Moreover, the sliding connection shaft 42 is arranged so as to be free to move along an axis of the sliding connection shaft 42.

For the first attachment portion 7 having the above-described structure, since the circle tube portion 47 of the fixing connection shaft 41 and the sliding connection shaft 42 are arranged rotatable with respect to the receiving part 40, the arm part 3 is rotatably connected to the sound emission part 4 so as to be free to rotate about the first axis P1 taken along the width direction of the arm part 3 (indicated by a dotted line in FIG. 1). In addition, the first axis P1 is arranged parallel to the third axis P3 while the first connecting member 12 of the second attachment portion 5 is positioned in the neutral position.

The case holder 38 constituting the first attachment portion 7 is arranged such that the tubular portion 44 is passed through an opening portion 55 formed in the vicinity of a central portion of a speaker case 10 and projects towards the arm part 3. A fixing member (screw) is passed through a through hole 62 formed at the case holder 38 and inserted into a concave portion 63 which is formed at the speaker case 10 and which has a thread-cut inner face, thereby fixing the case holder 38 to the speaker case 10. A projection portion 57 of a spring support member 54 is inserted into the case holder 38 to support the sliding connection shaft 42 received inside the case holder 38 and the coil spring 51 within the case holder 38. A fixing member (screw) is passed through a through hole 59 formed at the spring support member 54 and inserted into a concave portion 58 which is formed at the speaker case 10 and which has a thread-cut inner face, thereby fixing the spring support member to the speaker case 10.

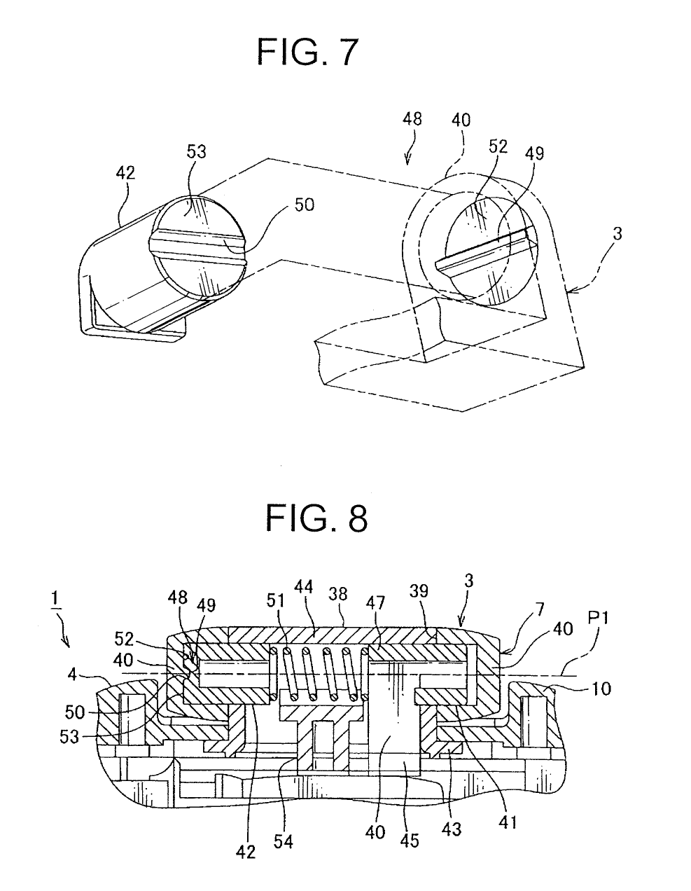

Furthermore, the headphone 1 includes a first maintaining body 48 as a first maintaining element. The first maintaining body 48, as shown in FIG. 7, includes a back face 52 as an inner face of the receiving part 40 formed so the receiving part 40 and the sliding connection shaft 42 engage with each other, an end face 53 of the sliding connection shaft 42, a linear convex portion 49 as a convex portion, a linear concave portion 50 as a concave portion and the coil spring 51 (shown in FIG. 8) as a first force-exerting member.

The linear convex portion 49 projects from the back face 52 located backmost in all inner faces of the receiving part 40 into which the sliding connection shaft 42 of the each first attachment portion 7 is inserted. The back face 52 faces the later-described end face 53 of the sliding connection shaft 42. The linear convex portion 49 extends linearly through a center of the back face 52.

The linear concave portion 50 is formed concavely on the end face 53 of the sliding connection shaft 42 of the each first attachment portion 7 located at a backmost position of the receiving part 40. The linear concave portion 50 extends linearly through a center of the end face 53. The linear convex portion 49 can be inserted into the linear concave portion 50. When the linear convex portion 49 is inserted into the linear concave portion 50, an outer surface of the linear convex portion 49 and an inner face of the linear concave portion 50 closely contact with each other, as well as the end face 53 and the back face 52 closely contact with each other. With the outer surface of the linear convex portion 49 and the inner face of the linear concave portion 50 closely contacting with each other as well as the end face 53 and the back face 52 closely contacting with each other, the linear convex portion 49 and the linear concave portion 50 engage with respect to each other.

The coil spring 51 is arranged between the sliding connection shaft 42 of the each first attachment portion 7 and the fixing connection shaft 41 and exerts a force on the sliding connection shaft 42 towards a back of the receiving part 40, i.e. exerts a force on the end face 53 towards the back face 52. Furthermore, the coil spring 51 is arranged between the shafts 41, 42 by the spring support member 54 (shown in FIG. 8) attached to the sound emission part 4. The coil spring 51 may be replaced with an elastic member such as the one constituted of rubber or the one constituted of polyurethane resin. In place of the coil spring 51, as long as such member can exert a force to the sliding connection shaft 42 towards the back the receiving part 40, i.e. to the end face 53 towards the back face 52. Also, a known elastic member may be selected arbitrarily and employed in place of the coil spring 51 with the purpose of, for example, suitably adjusting a force to be exerted. In addition, the linear convex portion 49 and the linear concave portion 50 may not extend linearly as long as the linear convex portion 49 and the linear concave portion 50 engage with each other.

For the first maintaining body 48 having the above-described structure, the coil spring 51 exerts a force on the sliding connection shaft 42 towards the back of the receiving part 40 and the linear convex portion 49 and the linear concave portion 50 engage with each other. Thereby first maintaining body 48 maintains relative positions of the sound emission part 4 and the arm part 3 about the first axis P1.

For the headphone 1 having the above-described structure, with the headband 2 being worn on a person's head and the cushion member 11 of the sound emission part 4 covering the person's ear, voice currents are supplied to the speaker unit of the each sound emission part 4, producing a sound according to the voice currents and transmitting the a sound to the person.

According to this embodiment, the first attachment portion 7 rotatably attaching the sound emission part 4 to the arm part 3 is attached to the central portion of the sound emission part 4. Consequently, the first attachment portion 7 can be prevented from being large, providing a relatively small storage space. In addition, an unexpected breakage of the first attachment portion 7 can be prevented.

Furthermore, there is provided the first maintaining body 48 maintaining relative positions of the sound emission part 4 and the arm part 3 about the first axis P1. Consequently, even with the first attachment portion 7, the sound emission part 4 can be prevented from rotating by little and little with respect to the arm part 3 when being carried around, preventing generation of an unwanted noise. Also, the arm part 3 can be prevented from rotating beyond a maximum allowable rotation range of the first attachment portion 7, preventing an unexpected breakage of the first attachment portion 7 and such.

Furthermore, the first maintaining body 48 includes the back face 52 and the end face 53 engaged with each other and the coil spring 51 exerting a force in a direction that the back face 52 and the end face 53 come near towards each other. In addition, the back face 52 includes the linear convex portion 49 and the end face 53 includes the linear concave portion 50, the linear convex portion 49 and the linear concave portion 50 extending linearly. Consequently, the first maintaining body 48 can maintain relative positions of the sound emission part 4 and the arm part 3 about the first axis P1.

Furthermore, a plurality of sliding connection shafts 42 is provided. The coil spring 51 is provided between these sliding connection shafts 42. Consequently, the first maintaining body 48 can further maintain relative positions of the sound emission part 4 and the arm part 3 about the first axis P1.

Furthermore, the first attachment portion 7 may include the cutout 39 provided at the arm part 3 and the case holder 38 placed within the cutout 39 and receiving the coil spring 51. Consequently, since the case holder 38 is placed within the cutout 39, the first attachment portion 7 can be downsized.

Furthermore, the case holder 38 includes the holder main body 43 formed into a plate-like shape and attached to the sound emission part 4 and the tubular portion 44 connecting to the holder main body 43 and receiving the coil spring 51. Consequently, the first attachment portion 7 can connect the arm part 3 and the sound emission part 4 about the first axis P1 without increasing the number of components.

The arm part 3 is curved convexly in the direction opposite to the sound emitting side. Consequently, the headphone 1 can be received within a relatively small storage space, when receiving the headphone device 1.

Furthermore, there is provided the second attachment portion 5 rotatably connecting the headband 2 and the arm part 3 about the second axis P2. Consequently, the sound emission part 4 can be positioned in an arbitral direction.

Furthermore, in addition to the second attachment portion 5, there is provided the third attachment portion 6 rotatably connecting the second attachment portion 5 and the arm part 3 about the third axis P3 perpendicular to the second axis P2. Consequently, the sound emission part 4 can be folded so the sound emission part 4 is in close contact with the headband 2.

Furthermore, there is provided the helical coil spring 16 exerting a force on the arm part 3 towards the neutral position when the arm part 3 supporting the sound emission part 4 is rotated with respect to the headband 2. Consequently, when using, in the arm part 3 supporting the sound emission part 4 is rotated and is returned back in the neutral position, the arm part 3 is returned in the neutral position by a force exerted by the helical coil spring 16.

Accordingly, in a state in which no external force is applied to the sound emission part 4, for example when not in use, the arm part 3 is maintained in the neutral position. Thus, the sound emission part 4 can be prevented from rotating by little and little with respect to headband 2 when being carried around, preventing generation of an unwanted noise. In addition, since the arm part 3, i.e. the sound emission part 4, can be positioned in the neutral position, the arm part 3 can be prevented from rotating beyond a maximum allowable rotation range of the second attachment portion 5, preventing an unexpected breakage of the second attachment portion 5 and such.

Furthermore, in the present invention, the helical coil spring 16 includes the annular elastic deformation portion 22 and the pair of stick-like portions 23. One stick-like portion 23 is attached to the arm part 3 and the other stick-like portion 23 is attached to the headband 2. Consequently, the helical coil spring 16 can exert a force on the arm part 3 towards the neutral position with a simple structure.

Furthermore, there is provided the second maintaining body 30 maintaining relative positions of the second attachment portion 5 and the arm part 3 about the third axis P3. Consequently, even with the third attachment portion 6 provided in addition to the first attachment portion 5 and the second attachment portion 7, the sound emission part 4 can be prevented from rotating by little and little with respect to the headband 2 when being carried around, preventing generation of an unwanted noise. Also, the arm part 3 can be prevented from rotating beyond a maximum allowable rotation range of the third attachment portion 6, preventing an unexpected breakage of the third attachment portion 6 and such.

Furthermore, there is provided the connecting member 28 integrally including the first connecting member 12 constituting the second attachment portion 5 and the second connecting member 24 constituting the third attachment portion 6. Consequently, when the first connecting member 12 and the second connecting member 24 are arranged separately, it is prevented the headphone from growing in size. Also, even with the third attachment portion 6 provided in addition to the first attachment portion 5 and the second attachment portion 7, an increase in the number of components can be prevented.

Furthermore, the first connecting member 12 is formed into a tubular to shape receiving the helical coil spring 16 and the second connecting member 24 is formed into a tubular shape receiving the shaft 27. Consequently, even with the third attachment portion 6 provided in addition to the first attachment portion 5 and the second attachment portion 7, the headphone 1 can be prevented from being large.

Furthermore, the second maintaining body 30 includes the circular concave portions 32 arranged on the outer circumferential face of the second connecting member 24 along the circumferential direction at an interval, the projecting plate 34 arranged to project from and retract into the arm part 3 and arranged to engage with the circular concave portion 32, and the coil spring 35 exerting a force on the projecting plate 34 towards the outer circumferential face of the second connecting member 24. Consequently, the second maintaining body 30 can reliably maintain relative positions of the second attachment portion 5 and the arm part 3 about the third axis P3.

Furthermore, the arm part 3 includes the cutout 25 for disposing the second connecting member 24, and the shaft 27 penetrates through the arm part 3 and the second connecting member 24. Consequently, downsizing can be achieved.

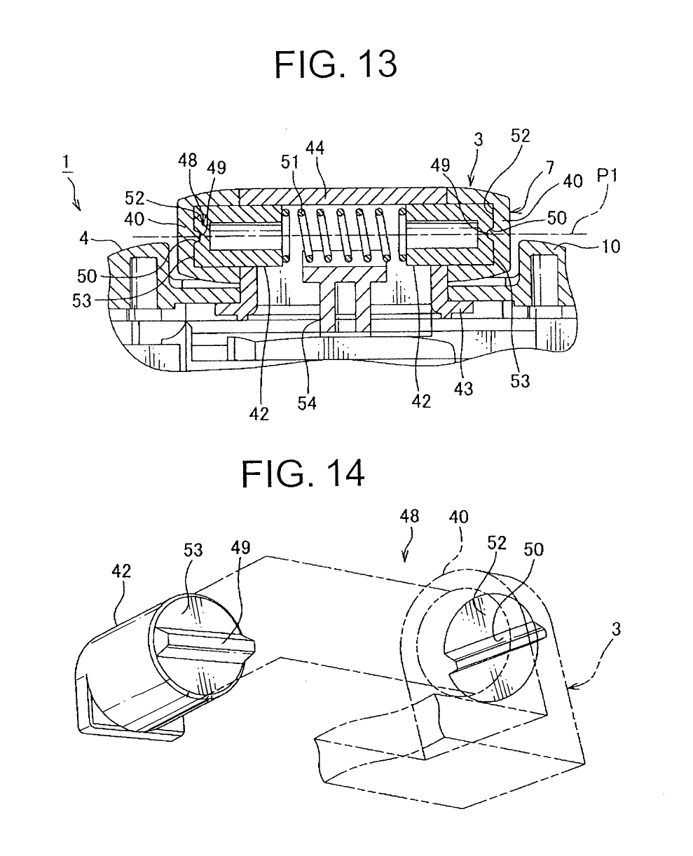

In the above-described exemplary embodiment, although the each first attachment portion 7 includes the fixing connection shaft 41 and the sliding connection shaft 42; however, in the present invention, the first attachment portion 7 may include a pair of sliding connection shafts 42, i.e. a plurality of sliding connection shafts 42, and the coil spring 51 of the first maintaining body 48 may be arranged between the pair or plurality of sliding connection shafts 42, as shown in FIG. 13. In this case, the first maintaining body 48 can even more securely maintain relative positions of the sound emission part 4 and the arm parts 3 about the first axis P1. In FIG. 13, the same reference signs are used for the components corresponding to those of the above-described exemplary embodiment.

Furthermore, in the above-described exemplary embodiment, although the linear convex portion 49 is provided at the back face 52 and the linear concave portion 50 is provided at the end face 53; however, in the present invention, the linear convex portion 49 may be provided at the end face 53 and the linear concave portion 50 may be provided at the back face 52, as shown in FIG. 14. In FIG. 14, the same reference signs are used for the components corresponding to those of the above-described exemplary embodiment.

According to the above-described exemplary embodiment, there are provided below-described headphone 1.

### APPENDIX

A headphone including:

a headband 2;

a band-plate-like arm part 3 connected to the headband 2;

a sound emission part 4 supported by the arm part 3;

a first attachment portion 7 rotatably connecting the arm part 3 with a central portion of the sound emission part 4 on a side opposite to a sound emitting side of the sound emission part 4 about a first axis P1 along a width direction of the arm part 3; and a first maintaining body 48 maintaining relative positions of the sound emission part 4 and the arm part 3 about the first axis P1.

According to the appendix, the first attachment portion 7 rotatably connecting the sound emission part 4 with the arm part 3 is attached at the central portion of the sound emission part 4. Consequently, the first attachment portion 7 can be prevented from being large. And a small storage space can be comparatively small. Furthermore, an unexpected breakage of the first attachment portion 7 can be prevented.

Furthermore, there is provided the first maintaining body 48 maintaining relative positions of the sound emission part 4 and the arm part 3 about the first axis P1. Consequently, even there is provided the first attachment portion 7, the sound emission part 4 can be prevented from rotating by little and little with respect to the arm part 3 when being carried around, preventing generation of an unwanted noise. Also, the arm part 3 can be prevented from rotating beyond a maximum allowable rotation range of the first attachment portion 7, preventing an unexpected breakage of the first attachment portions 7.

The above-described exemplary embodiments are representative embodiments of the present invention, and the present invention is not limited thereto. That is, various changes can be made without departing the scope of the present invention.

1. A headphone comprising:
a headband;
a band-plate-like arm part connected to the headband;
a sound emission part supported by the arm part;
a first attachment portion rotatably connecting the arm part with a central portion of the sound emission part on a side opposite to a sound emitting side of the sound emission part about a first axis along a width direction of the arm part; and
to a first maintaining element maintaining relative positions of the sound emission part and the arm part about the first axis.

2. The headphone according to claim 1, wherein
the first attachment portion includes a receiving part provided at the arm part and a receiving counter member provided at the sound emission part, wherein
the receiving counter member is received rotatably about the first axis relatively with respect to the receiving part in the receiving part, and the first maintaining element includes an inner face of the receiving part and an end face of the receiving counter member, which are formed so the receiving part engages with the receiving counter member, and a first force-exerting member exerting a force on the end face of the receiving counter member towards the inner face of the receiving part.

3. The headphone according to claim 1, wherein one of the end face of the receiving counter member and the inner face of the receiving part includes a convex portion, and the other one of the end face of the receiving counter member and the inner face of the receiving part includes a concave portion.

4. The headphone according to claim 3, wherein the convex portion and the concave portion are formed to extend linearly.

5. The headphone according to claim 4, wherein the first attachment portion includes: a cutout provided at an end portion of the arm part adjacent to the sound emission part; and a receiving member arranged in the cutout and attached to the sound emission part and receiving the first force-exerting member.

6. The headphone according to claim 5, wherein the receiving member includes: a plate portion formed into a plate-like shape and attached at the sound emission part; and a tube-like tubular portion connecting to the plate portion and receiving the first force-exerting member.

7. The headphone according to claim 6, wherein the arm part is curved in a direction opposite to the sound emitting side of the sound emission part and is curved from an end portion of the arm part adjacent to the headband to an end portion of the arm part adjacent to the sound emission part.

8. The headphone according to claim 7, comprising
a second attachment portion rotatably connecting the headband and the arm part about a second axis running from the headband toward the arm part.

9. The headphone according to claim 8, comprising
a third attachment portion rotatably connecting the second attachment portion and the arm part about a third axis substantially parallel to a width direction of the headband and perpendicular to the second axis.

10. The headphone according to claim 9, wherein the second attachment portion includes a force-exerting element exerting a force on the arm part so the arm part is positioned in a neutral position with respect to the headband when the arm part is rotated around the second axis.

11. The headphone according to claim 10, wherein
the force-exerting element includes an annular elastic deformation portion and a pair of stick-like portions formed into a stick-like shape and extending from the elastic deformation portion in an outer circumferential direction of the elastic deformation portion, wherein
one of the pair of the stick-like portions is attached to the arm part and the other one of the pair of the stick-like portions is attached to the headband.

12. The headphone according to claim 11, comprising a second maintaining element maintaining relative positions of the second attachment portion and the arm part about the third axis.

13. The headphone according to claim 9, comprising a connecting member integrally including a first connecting member and a second connecting member, wherein
the first connecting member constitutes the second attachment portion and is attached to the headband, and
the second connecting member constitutes the third attachment portion and is attached to the arm part.

14. The headphone according to claim 13, wherein
the first connecting member is formed into a tubular shape and receives the force-exerting element thereinside, and
the second connecting member is arranged to intersect with the first connecting member and is formed into a tubular shape connecting to the first connecting member, wherein
the second connecting member receives a shaft constituting the third attachment portion.

15. The headphone according to claim 14, wherein
the second maintaining element includes: a plurality of engagement counter members arranged at an outer circumferential face of the second connecting member and arranged along a circumferential direction at an interval; an engaging member arranged to project and retract from the arm part towards the second connecting member and engages with the engagement counter member; and a second force-exerting member exerting a force on the engaging member towards the second connecting member.

16. The headphone according to claim 15, wherein
the arm part includes a cutout,
the second connecting member is arranged in the cutout, and
the shaft penetrates through the arm part and the second connecting member.

17. The headphone according to claim 2, comprising,
a second attachment portion rotatably connecting the headband and the arm part about a second axis running from the headband to the arm part.

18. The headphone according to claim 17, wherein the second attachment portion includes a force-exerting element exerting a force on the arm part so the arm part is positioned in a neutral position with respect to the headband when the arm part is rotated around the second axis.

19. The headphone according to claim 18, comprising
a third attachment portion rotatably connecting the second attachment portion and the arm part about a third axis substantially parallel to a width direction of the headband and perpendicular to the second axis, and
a connecting member integrally including a first connecting member and a second connecting member, wherein
the first connecting member constitutes the second attachment portion and is attached to the headband, and the second connecting member constitutes the third attachment portion and is attached to the arm part.

20. The headphone according to claim 2, wherein
the first attachment portion includes a plurality of receiving parts and a plurality of the receiving counter members, wherein
the plurality of receiving parts position the receiving counter members therebetween, and
the first force-exerting member of the first maintaining element is arranged between the plurality of the receiving counter members.
